(19) United States
(12) Patent Application Publication
(10) Pub. No.: US 2004/0138900 A1
(43) Pub. Date: Jul. 15, 2004

(54) Computerized random variable selector, apparatus, system and method

(76) Inventor: Theresa Karem Read, Conyers, GA (US)

Correspondence Address: Theresa K. Read, 3660 Druids Drive, Conyers, GA, 30013, US

(21) Appl. No.: 10/341,799

(22) Filed: Jan. 14, 2003

(51) Int. Cl. G06F 17/60

(52) U.S. Cl. 705/1

(57) ABSTRACT

A computerized method, system and apparatus for automated, random selection of one or more variables selected by one or more participants from a larger group of variables, which may be obtained, if desired, from a directory, catalog or other group located on a Internet website or other communications linkage, through at least one central processing unit including operation system software for controlling the central processing unit. Preferably the method, system and apparatus allows for the collection and processing of variables submitted by multiple parties, then provides for notification to each participant of the variable or variables randomly chosen through the operation of the system. Preferably, where the group of variables chosen from are comprised of individuals listed in a directory, the method, system and apparatus also provides for notification to the selected individual that he has been randomly chosen by the participants in the process.

### CROSS-REFERENCE TO RELATED APPLICATIONS

Not applicable

### FEDERALLY SPONSORED RESEARCH

Not applicable

### BACKGROUND OF THE INVENTION

1. Field of Invention

This invention relates generally to computerized systems for automated random variable selection from one or more variables chosen from a directory, catalog or other group of variables and submitted by one or more participants through a communications linkage for communicating and processing a series of submissions by the participants, activating the final random variable selection procedure, and notifying the participants of the final variable selection. Where the variables are chosen from a pool of individuals, entities, companies or organizations, those individuals, entities, companies or organizations selected by the final random variable procedure are also notified of their selection. This invention relates more particularly to a computerized system for random selection of one or more alternative dispute resolution neutrals, such as a mediator or arbitrator, from one or more neutral choices made from a directory of such neutrals by one or more participants through a communications linkage for communicating and processing the participants' submissions, for activating the final neutral selection procedure and for notifying both the participants and the neutral. The invention also relates to a system for the collection, processing, and dissemination of session data generated from the sessions where random variable selection was completed.

2. Background of Invention

In both the personal and business arenas of life, there are situations where a groups, companies, organizations, etc., need to make a selection, binding on and adhered to by all, from a larger number of variables, using a completely random method so that they feel confident that they each had equal input into the selection process. The present invention is designed to provide a computerized, automated method for doing this. It includes the method, system and application for applying the random selection process to the business and personal sectors, including the Alternative Dispute Resolution (“ADR”) and legal fields.

In the past fifteen years or so, it has become readily apparent to the public and legal professionals, that an alternative to the traditional legal route is needed for resolving disputes. As a result there has been a tremendous growth in the use of ADR for the resolution of claims ranging from personal injury disputes to construction disputes, and even domestic disputes. However, conventional ADR may still be costly and time consuming. With the growth in the Internet, a number of computerized, automated dispute resolution systems have developed in attempts to both speed up, and economize ADR. One way to further economize ADR is to find a way to eliminate or minimize the use of ADR “forums”. These forums are essentially brokers of ADR neutrals, who, for a substantial fee, provide access to arbitrators and mediators and provide rules for the conduction of the ADR process, including neutral selection. Numerous, non-forum related directories of arbitrators and mediators are published on the Internet, however, until now an initial problem with instituting ADR using ADR neutrals located by disputants in these directories has not been resolved.

### BACKGROUND OF INVENTION—OBJECTS AND ADVANTAGES

Prior to this point, it was difficult to have a process for unbiased selection of ADR neutrals from neutral directories that the disputant parties could have confidence in. The present invention is based on the premise that many business and social situations require a random variable selection process, so that participants, such as disputants in an ADR process, may continue in their social or business scenario confident in the fact that they have participated equally with all other participants in an unbiased decision making process.

### SUMMARY OF THE INVENTION

The present invention includes the operation system software controlling the central processing unit for a computerized system for automated, random variable selection through an Intranet website via the Internet or other communications linkage for communicating, where the following information transfers through at least one central processing unit: a series of submissions by participants consisting of the opening of a session for random variable selection; the setting of the parameters of the session, with said parameters including where desirable, identification of directory or data pool from which variable selection is to be made, identification of and number of participants, setting the number of variable choices to be submitted by each participant and setting the number of final random variables to be chosen from the variable choices submitted by all participants; the notification to participants that they have been invited to participate in a session; the receipt of variable choices from participants, automated random variable selection according to the session parameters after receipt of the last participant's variable choices; notification to all participants of the variable choices selected and, when required, notification to the chosen individual, entity, organization or company when the variable (s) chosen was such an individual, entity, organization or company, and; the closing of the session. Included in the invention, is use of the system by a session sponsor who performs administrative functions such as setting session parameters, but does not participate directly in the random selection process. The invention also includes the use of the system for random selection of any designated variable, including, location, date and time of an event. It additionally includes the use of the system for random selection of ADR neutrals, entities, companies, or organizations, from a directory of such ADR neutrals, entities, companies or organizations, providing for notification to participants in such a session and to the selected ADR neutrals, entities, companies or organizations.

The system has means for introducing information sent by an initiating party into the central processing unit corresponding to the identification of the session and its parameters, including, where desired, designating the directory or data pool of variables to be utilized in the session, the participants involved in the session, the number of variable choices to be made by each participant and the number of variables to be selected by the random variable selection process. The system has further means for storing the information corresponding to the identification of the session and the participants involved in the session, means for the central processing unit to send a series of information requests to the other identified participants to participate in the session, means for introducing information into the central processing unit corresponding to the variable choices made by the identified session participants from the identified directory or other data pool of variables. When desired, the system has means for allowing participants to strike out one or more variable choices selected by all other participants prior to the final random variable selection. It additionally contains means for making a random variable selection according to the session parameters from the variable choices submitted by participants, and means for notification to be sent to all session participants regarding the variable choices selected, including means for notifying the selected ADR neutrals, individuals, entities, companies, or organizations, where the variable choice was made from a directory of ADR neutrals, entities, companies or organizations or other directory of other professionals.

Preferably, the central processing unit receives information corresponding to variable selection choices from participants in a plurality of communications with the system over a period of time, for example, 30 days. Time keeping means records the entry of the variable choices submitted by participants over the selected time period. Automated selection means included in the system makes a random selection between the variable choices submitted according each sessions' parameters set by the initiating participant or session sponsor after the last participant enters his variable choices.

The system preferably is designed to allow a user to communicate with the system through a standard PC computer and modem via the Internet, and or through the use of a personal digital assistant or any other electronic device with Internet connection capacity. The system may also include a voice message system or means for generating voice messages to a person communicating with the system through a touch-tone or cell phone linkage to guide the person in the use of the system.

Security means are preferably included to make the system accessible only upon entry of a session identification number identifying the session, and/or combined with a security code corresponding to the session, and a participant security code corresponding to the session and identifying the participant, i.e. the person or representative thereof who is making the variable choices, for example the attorney for the person on whose behalf the variable choice is made.

The method of the present invention communicates and processes a series of variable choices made either by direct input by participants or by their input arising from use of a designated directory or other data pool through a computerized system for automated random variable selection having at least one central processing unit including operating system software for controlling the central processing unit, means for introducing information into the central processing unit corresponding to the identification of the session and the participants involved in the session, and memory means for storing the information corresponding to the identification of the session and the participants involved in the session.

The method comprises:

(a) introducing into the central processing unit information corresponding to one or more variable choices from an initial session participant into a data pool from which there will be conducted automated, computerized random variable selection,

(b) introducing into the central processing unit information corresponding to one or more variable choices from a second session participant into a data pool from which there will be conducted automated, computerized random variable selection,

(c) introducing into the central processing unit information corresponding to one or more variable choices from a third, fourth or fifth, etc., session participant into a data pool from which there will be conducted automated, computerized random variable selection,

(d) steps (b) and (c) occurring in any order,

(e) selecting one or more variables from the data pool established by participants through an automated, computerized method in accordance with pre-established session parameters and conditions,

(f) communicating the variable(s) selected to the participants, if applicable to a session sponsor, and, where the data pool is comprised of individuals, entities, organizations or companies, communicating the selection to the individual, entity, organization or company selected.

### BRIEF DESCRIPTION OF THE DRAWINGS

The following detailed description may best be understood by reference to the following description in conjunction with the accompanying drawings in which:

FIG. 1 is an overview of the computerized system of the present invention.

FIG. 2 is a block diagram showing how a participant involved in a session for random variable selection interacts with the computerized system of this invention.

FIG. 3 is a block diagram of an example of how an embodiment of the computerized system of this invention prompts a person involved in a session in the use of the system.

FIG. 4 is a diagram showing the program flow from a user perspective in accordance with a preferred method for operating the system of the present invention via the Internet.

### DETAILED DESCRIPTION OF THE INVENTION

The present invention is a computerized system for automated random variable selection, operating, where desired, through an Internet website or other communications linkage 1, for communicating and processing a pre-set number of variable choices which may be made from a designated variable directory or data pool by or on behalf of one or more random variable selection session participants 2, 3, 4, 5, 6, 7, 8, 9.

Information corresponding to the variable choices made by participants in a session will be entered by the participant or his or her representative 1,2, by using the numbers of a personal digital assistant (“PDA”), touch-tone or cellular telephone or by typing the numbers on the keyboard of a personal computer while accessing the system via a web browser.

The system communicates and processes the submitted information for a session through at least one central processing unit and includes operating system software for controlling the central processing unit 8, means for introducing information into the central processing unit 8 corresponding to the identification of the session and the session participants, and memory means 9 for storing the identification of the session and the participants involved in the session.

Preferably, the computer is secure, for example by the implementation of a “firewall” or protective barrier against unauthorized traffic or the use of encryption technology, and each session is preferably double or triple-password protected to assure privacy and prevent unauthorized access. For example, the system may require the participant to enter a password or participant identification number or alphanumeric combination and a participant authorization code providing access control to the system. For increased security, systems may be designed which require participation authentication, for example through the use of voice pattern, fingerprints, physical signature, or “smart” card.

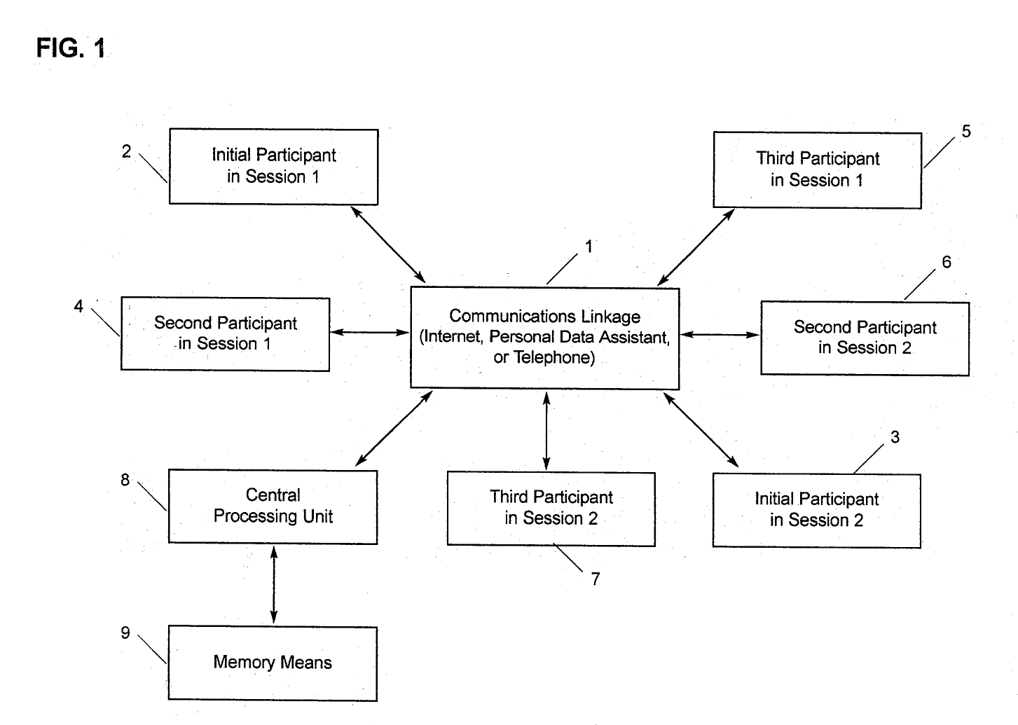

FIG. 1 shows the system of this invention using the Internet, PDA, cell phone or telephone as the communications linkage.

A participant involved in a random variable selection session is anyone or any company who participates in a process calling for the neutral, unbiased selection of any variable from a designated data pool. One or more participants may be involved in the random variable selection session. A session participant may or may not be a disputant, or his or her representative, involved in Alternative Dispute Resolution and the variable selection pool may or may not be comprised of a directory of arbitrators or mediators. The system includes:

means for introducing by or on behalf of sponsor organization or an initial participant involved in the session information into the central processing unit setting the parameters of the session, information corresponding to the identification of the session, information identifying the directory or data pool of variables to be utilized in the session, information identifying the participants involved in the session, information regarding the number of variable choices to be made by each participant and information regarding the number of variables to be selected by the random variable selection process,

means for storing the information corresponding to the identification of the session and the participants involved in the session,

means for the central processing unit to send a series of information requests to the other identified participants to participate in the session,

means for introducing information into the central processing unit corresponding to the variable choices made by the identified session participants from the identified directory or other data pool of variables,

means for allowing the variable selection choices made by each session participant to remain undisclosed to the other session participants where nondisclosure is desired,

means for making a random variable selection according to the session parameters from the variable choices submitted by participants,

means for notification to be sent to all session participants regarding the variable choices selected, including means for notifying the selected ADR neutrals, individuals, entities, companies, or organizations, where the variable choice was made from a directory of ADR neutrals, entities, companies or organizations or other directory of other professionals.

Thus, the random variable selection system can be utilized without direct contact being made between session participants.

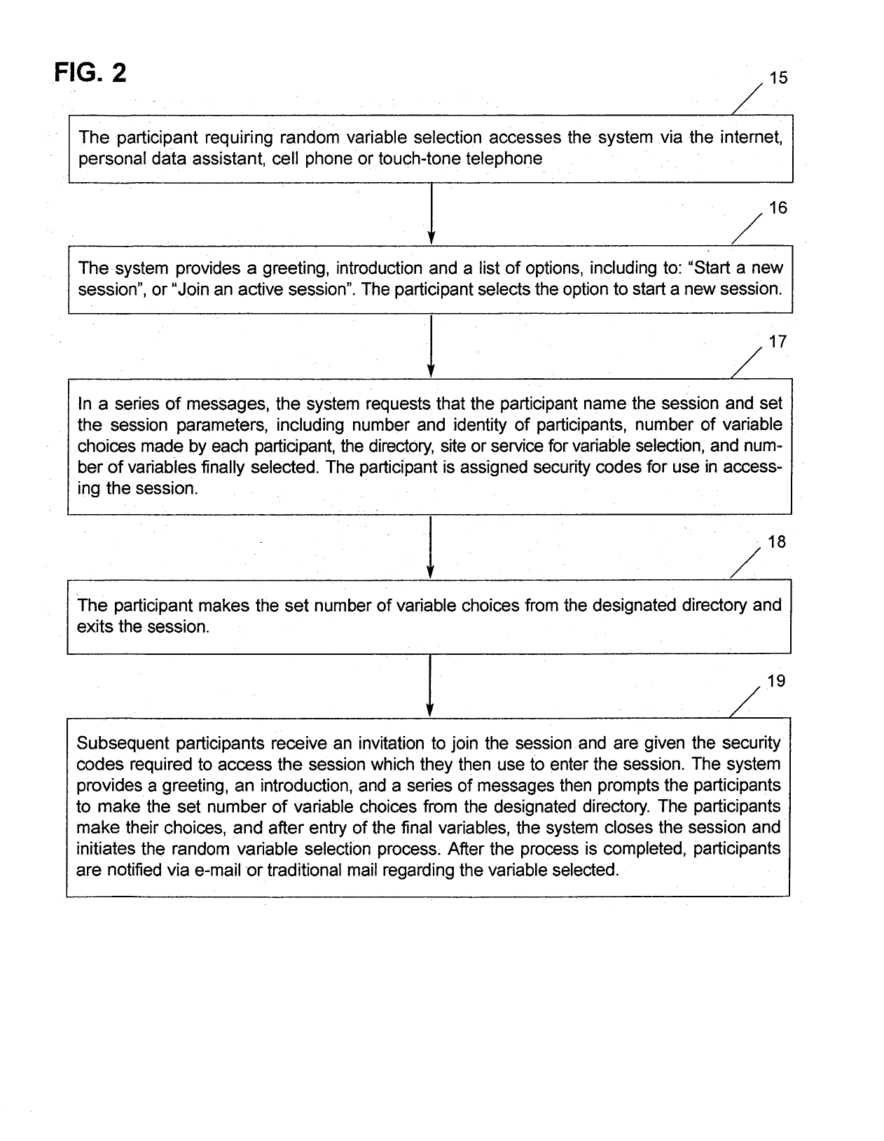

FIG. 2 shows how a participant involved in a random variable selection session would use the confidential and automated system of this invention without direct communication with the other side.

The system preferably also comprises security means whereby the system is accessible only upon entry of a session identification number identifying the session, and a participant security code corresponding to the session and identifying the session participant or representative thereof.

Preferably, the system comprises means for generating voice or text messages to a person communicating with the system through a personal digital assistant, touch tone or a cellular phone linkage which guides the person in the use of the system. Additionally, written or verbal messages may be used as prompts when the system is accessed from a personal computer via the Internet.

The opening of a session and entry of variable choices may also be expedited by a trained staff of professionals. A session sponsor may assist participants in the random selection process by pre-designating one or more of the session parameters. These pre-designated parameters may or may not include, directory or variable grouping from which variable choices should be made, and time, date and place of any event associated with the final variable selection. Such a sponsor may or may not be a forum hosting ADR services, a governmental entity, an insurance company, a chamber of commerce or other organization providing administration services compatible with the random selection process.

The professional administrator or session sponsor may additionally provide support services for utilitization by participants in the process. For example, the sponsor may offer support by way of website or telephone linkage, providing a series of options, one of which places the participant into on-line or telephone communication with a customer service representative to answer questions or provide other assistance. Thereafter, the participant may access the system by communicating to the processing unit via the Internet or by telephone, e.g. a toll-free number, at any time or day of the week to obtain information regarding variable choices, or entry of session information. Preferably, the system comprises time keeping means to record the introduction of the information corresponding to a participant's entry of variable selection choices over a period of time. In this way, introduction of information corresponding to variable selection choices may be made in a plurality of communications with the system over a period of time. The system can handle multiple telephone calls or other communications from anywhere in the world. The computer performs its functions and the results are reported to the participants as they occur in real time without waiting.

Preferably, session participants have only three or some other previously agreed-upon number of opportunities or rounds to make variable choices using the system, and preferably there is an over-all time limit on the session in which all participants must make all variable choices, for example thirty days for all choices to be made, which encourages prompt action by session participants.

The system preferably also collects and processes session data generated from sessions reached through the operation of the system for dissemination and use by users, for example sponsors and participants, in marketing or future selection sessions. Means may be provided for a participant to access actual session results achieved through the use of the system in other sessions, for example, through a menu or voice choice provided to the user via telephone or the Internet whose selection provides the participant with information about prior sessions. The data may be tabulated in the memory means so as to be accessible by certain categories, for example by directory, by individual directory listing, by ADR forum or organization, by court, by sponsor, by geographic location, or by other category. In this way, a participant or session sponsor can be guided in making choices so a more successful use of the system may result.

The invention can be understood readily from the following description of a preferred embodiment in conjunction with the overview of FIG. 1. The present invention provides an online system accessed preferably from an Internet website, PDA, cell phone or telephone to facilitate the selection by one or more participants of one or more variables, obtained where desired from a designated directory or data pool where the participants may be attorneys, claims adjusters, claims disputants, organizations, companies, governmental entities or individuals. The system allows the participants to use a simple interface to rapidly post variable selection choices and initiate the variable selection process. Preferably, the system also calculates, stores and tabulates session data after a session closes for reference by future participants.

In non-sponsored sessions, the participants may agree in advance to the parameters of a session, with the first participant who logs on entering this data.

A participant involved in a business, personal or legal matter, such as a party in a legal dispute, an attorney, an ADR forum or organization, a governmental entity, an insurer, preferably submits random variable selection session information to the computerized system using electronic media and formats agreed upon by all participants in the random variable selection session, or previously designated by a session sponsor. The participants and/or session sponsor preferably can also designate one or more parameters for random variable selection session, number of variable choices selected by participants, number of final variables selected by the process, any directory, or data group from which variable choices should be made, and time, date and location of any event associated with variable selection. Claimant attorneys may participate in the process as representatives of their parties, logging into the system by special authorization codes.

In an Internet-based embodiment of the present invention, the interface between the system and the participant is located at an Internet website hosting a directory, catalog, or other group of variables. Preferably, the major areas of the website include a login area for participants, sponsors or their representatives, claimants or attorneys for claimants, and a login area for administration personnel who oversee the system. If desired, the website may also include a publicly accessible area that highlights information about the system. For increased security, a separate website may be set up with this information.

Individuals using the computerized system preferably must log into the system before they can manipulate any data. Preferably, they can view, enter and change only that information that is within their access limits—as an attorney for a participant, a sponsor user, a sponsor administrator, or a system administrator. A sponsor user is a organization, entity, company or agency, or an alternative dispute resolution (“ADR”) forum, ADR organization, ADR entity, ADR company, governmental agency offering ADR, claims adjuster or other agent who works for a sponsor, for example an insurance company or large self-insured organization, which has entered into an agreement to use the computerized system. A sponsor user is preferably limited to entering and reviewing sessions relevant to their own entered cases, not sessions entered by other sponsor users of the same sponsor.

Thus, a sponsor user preferably may enter the website to login to the system, for example by using a user name and password combination or pair, read and agree to an agreement for the sponsor's participation in the system, assign new sessions for participant or attorney participation, and review any completed, pending or in-process sessions that have been entered into the system by that sponsor user.

A sponsor organization has administrative privileges to use and administer the system. A sponsor organization includes a sponsor administrator or user who has been granted administrator privileges by the sponsor. Preferably, in addition to performing all the tasks that a regular sponsor user may perform, a sponsor administrator may enter the website to change sponsor contact information, change sponsor user login and contact information, add or delete sponsor users, create sponsor users with administrator privileges, and review sessions for all sponsor users within the sponsor.

Participants or their attorneys may enter the website to login to the system preferably using a username and password pair, read and agree to a system participation agreement for the claimant, review session parameter information as prepared by the sponsor, obtain current session status information, post variables selection choices, and, where permitted, strike selection choices made by other participants.

Preferably, system administrators who work for a company administering the system assist in the implementation of the system. System administrators with proper authorization, for example username/password combination identifying them as such, may enter the website to review, modify, delete and create sponsors, sponsor users, and sponsor administrators, and review, modify and delete and create cases or claims to be processed by the system. Preferably, a session report writer may be provided containing current session status information searchable by date, sponsor, sponsor user, session name and status, which is able to be accessed or queried by the system administrator. A more limited form of session report writer may also be provided to participants and other users of the system in which only information that is within the user's access limit may be searched.

The system of the present invention is preferably designed to make it easy for a participant, his attorney or other representative with any common Internet, PDA, cell phone or telephone access to easily use the random variable selection process to make one or more random variable choices regardless of whether said variable choices are ADR neutrals, or other such variables, including other professionals, and the time, date, or location of any related event.

In using the system, the sponsor accesses the system, for example, with a login to the website. The sponsor may at that time enter any pertinent case information about the session, and the session participants. After entry of such information, notification to session participants is automatically sent by the system. The participants then utilize the system to make their variable selection choices, with the automatic random variable selection process activated after the last participant's entry of his or her variable choices. The system then generates notices to all participants, and to the selected companies, professionals, arbitrators or mediators where the variables selected are from a directory of companies, professionals, arbitrators or mediators.

Following the opening of a session by the initial participant, the other participants, their attorneys or representatives are contacted by ordinary or electronic mail. The participant is given an attorney security code, which is preferably a unique numeric personal identification number (“pin number”) that permits the participant to access the session via the computerized system. Where desired, the participant may agree to be bound by the final variable selection choice made by the computerized, automated variable selection system. The participant signs on, and is given access to the session for variable selection. He or she then has a pre-set number of opportunities to make a pre-set number of variable choices that will become part of the data pool from which the final variable selection shall be made.

Referring now to the block diagram of FIG. 2, the participant or other user (for example an ADR organization or sponsor) accesses the system via the Internet using any standard web browser or via a personal digital assistant, ordinary touch-tone or cellular telephone 15. No special equipment or training is needed by the participant to use the system. The system “prompts” the participant at each step of the process and provides automated, on-demand help if needed.

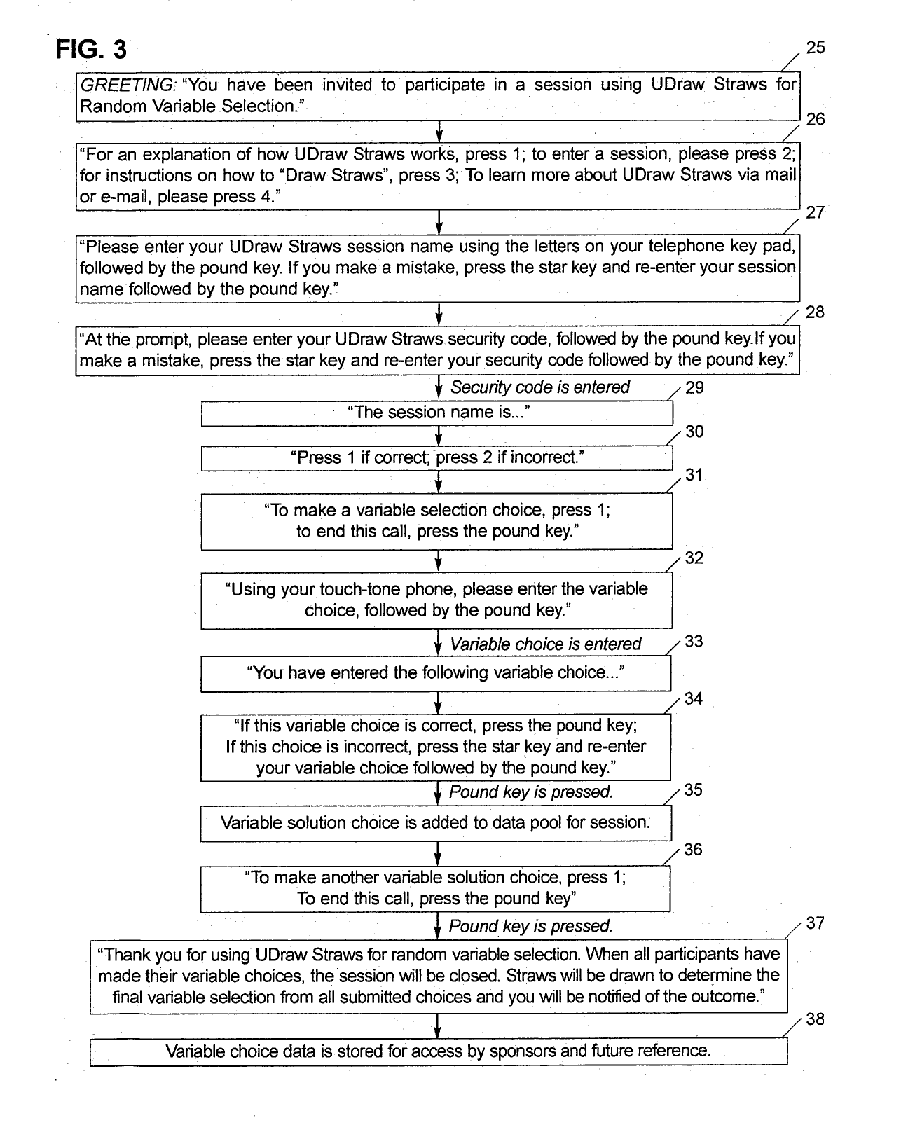

For example, referring to the block diagrams of FIG. 2 and FIG. 3, upon accessing the system, the user is met with a greeting 15 (step 25) followed by a number of options 16 that may be selected by pressing the appropriate number of a personal digital assistant, touch-tone or cellular telephone (step 26).

In steps 27-30, the participant's pin number and preferably two numeric “passwords” are required to access a session for random variable selection. The system preferably generates a voice confirmation of the information which the user may confirm or cancel and reenter the information (see step 29). The system may, upon confirmation of the information, determine the correctness of the information and the user's authorization to access the system for that session. After entry and confirmation of the required numbers 17, the participant follows the prompts and enters variable selection choices 18 using the keypad of his personal digital assistant or telephone or by typing the choices in at his or her personal computer. The system may also request confirmation of information entered by the participant. See FIG. 3 for telephone-based embodiments.

The computerized system is designed to make random variable selection from participant submitted group of variables. When set up to make a random selection of ADR neutrals submitted by participants, no information concerning the facts, the law, the injuries claimed or any other matter pertaining to the issues sought to be resolved through use of alternative dispute resolution is required by the system. However, when set up to be administered by a session sponsor, the session sponsor may utilize pre-designations requirements, such as ADR neutral background, case facts and fields of law involved, to narrow the submissions into the final data pool from an ADR neutral will be finally selected.

Variable choices may preferably be completed in one, two or three computer sessions within a given time period, preferably thirty days. Once entered, the system instantly adds the variable choices made to the data pool from which the random variable selection shall be made.

An example of the results from three participants'session using the system for random arbitrator selection is given in Table 1. In this example, the first pre-established condition, set by the initial participant, is that each participant selects four arbitrator choices from a designated directory of arbitrators. These choices are placed by the system into the data pool from which the final random arbitrator selection will be made. The second pre-established condition is that three arbitrators will be selected by the random variable selection process as the arbitrator panel agreed upon by the participants to resolve their dispute.

TABLE 1
ARBITRATOR CHOICES:
1st Participant's Session Choices

| | |
|---|---|
| 1 | Jim Blackwell, Esq. |
| 2 | Tonya Hart, Esq. |
| 3 | Sheryl Sidway, Esq. |
| 4 | Robert Bill, Esq. |

2nd Participant's Session Choices

| | |
|---|---|
| 1 | Alan Simber, Esq. |
| 2 | Robby Robford, Esq. |
| 3 | David Malva, Esq. |
| 4 | Paul Land, Esq. |

3^{rd} Participant's Session Choices

| | |
|---|---|
| 1 | Mary Martin, Esq. |
| 2 | Russell Roberd, Esq. |
| 3 | Bruce Wolf, Esq. |
| 4 | Patrick Polart, Esq. |

Random, System Selected Arbitrator Panel:

1 Robert Bill, Esq.

2 David Malva, Esq.

3 Paul Land, Esq.

The processing of the session data within the present invention begins when a participant involved in business or personal matter requiring random variable selection, for example, a party requiring selection of a neutral arbitrator for resolution of a legal dispute, or a session sponsor, enters into the central processing unit a series of data submissions made electronically in a format compatible with the system, for example via phone or personal digital assistant input or PC input fed to the central processing unit. These initial data submissions 17 set the parameters for the session, including identifying the other participants in the session, identifying the directory or other data pool from which variable choices will be made by the participants, the number of variable choices to be made by each participant and the number of variables to be selected by the operation of the random variable selection mechanism. Variable pre-designations may also include minimum background requirements for professional selection, such as experience and education background when the variables selected are professionals be selected to perform a function of their profession.

The processing continues with the system automatically sending out notices to all other participants identified by the initial participant that they have been invited to participate in a session for random variable selection 18 from a particular directory. Notification is given either while the invited participant is online or via email to offline invitees or by telephone or personal digital assistant and preferably follows that notice with a written confirmation. The invited participants input a series of data submissions into the central processing unit in a format compatible with the system. These submissions include the passwords and ID codes required to log into a session and the pre-set number of variable choices from the designated directory or data pool.

The processing is finalized when the last participant to log into the session, enters the last variable choice permitted by the pre-set conditions of the session, and logs out. The random variable selection process activates after log out of the last participant 19. The process makes the final selection of variables chosen in the session, and sends out notices to all participants, and where applicable to individuals where said individuals were selected from a directory, such as a directory of ADR neutrals 19. Preferably, the system promptly notifies the participants, and where applicable the randomly selected individual professionals, of the final selection from the random variable selection process. Notification is given either while the participants are online or via email to offline participants or by telephone or personal digital assistant and preferably followed with a written confirmation.

The computerized random variable selection process may be implemented in Internet-based embodiments using a computer program representing a distributed database application written in a Mark-up Language such as Cold Fusion Markup Language and HyperText Markup Language (HTML). The system preferably is distributed through ColdFusion Server extensions which allow for interactive processing and Microsoft's SQLserver to allow participants, session sponsors, ADR forums, companies, organizations, entities, governmental bodies, attorneys and claims adjusters to access it via a standard web browser such as Microsoft Internet Explorer and Netscape Navigator, which can be found on a variety of platforms, including Microsoft Windows, Macintosh, and UNIX operating systems.

In an Internet based embodiment, information which is entered is submitted to a central database via the Internet. The database preferably indexes session sponsors, sponsor users and administrators associated with that sponsor, and sessions associated with that sponsor. It also preferably indexes attorneys associated with sessions.

Preferably, if a period of time passes without activity when a participant, session sponsor or other user is online, for example 20 minutes under normal network traffic conditions, the user is automatically logged out for security precautions. For all or a portion of the data, the system may be designed so that once data has been entered, a participant, sponsor or other user has a period of time, for example 20 minutes, after which the data cannot be withdrawn.

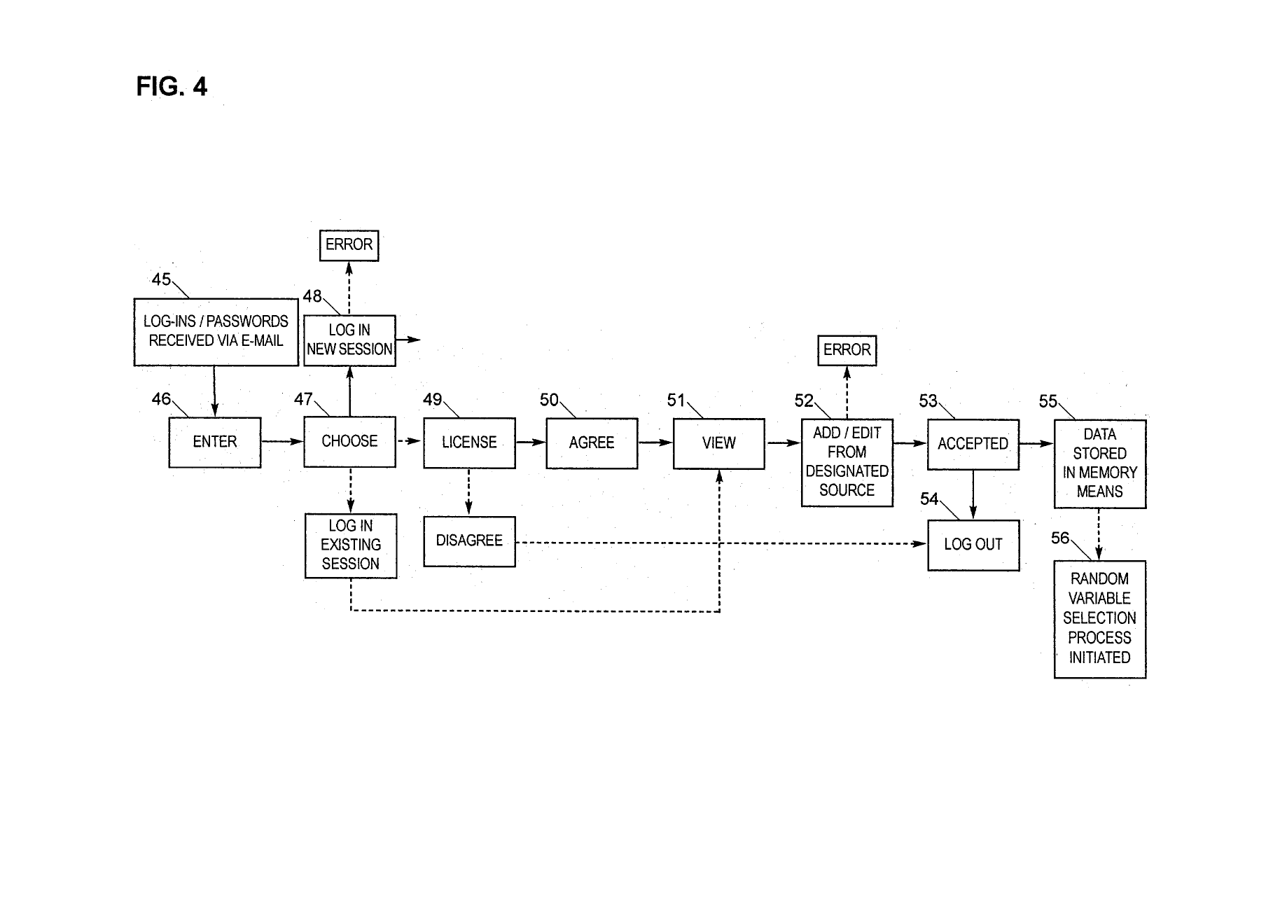

Referring now to the flow chart of FIG. 4, the preferred computer program implementing the system enters at step 45 when a participant or sponsor receives their log in and passwords required to access a session, then opens their web browser (for example Netscape or Microsoft Internet Explorer 3.x or 4.x) and accesses the system website 46. The user is prompted by a menu with a series of options 47, preferably one of which is “enter as Participant” which is chosen. If desired, the system may automatically write information in the form of ASCII text or “cookies” onto the user's hard drive as a means of keeping track of the user and the user's use of the system. Preferably, the memory means stores this information. Upon access to the system by the participant, any pre-existing cookies of the user may be modified to reflect the current access of the system by the user. Unless the user has explicitly denied cookies on his or her browser, the computerized system checks for the user's name through a variable saved in the user's browser. If the user has logged in before, the user is greeted by username, provided the user is logging in with the same computer.

In step 47, the participant user is presented with the choice of logging on into an existing session or starting a new session. After making this choice, the participant logs in 48. The participant must enter a session and or username (unique to the entire database) and a corresponding password. If these do not match the pairs known by the system, the user is shown an error screen with a prompt to try again. If this is the first time for log in by this participant at his present computer, then the participant must enter his agreement 50 to a license 49 before viewing the add/edit menu 51, 52.

Alternately, if the participant has logged in previously with the same computer, his or her username may already be entered into the system, and the server which distributes the web pages will check the user's password against the username. If desired, the system may be designed so that the user has the option to enter a new or different username to allow multiple users to access the system from the same computer. Once the participant is cleared as being a previous user, the participant may be permitted to by-pass the license and agreement stages (49, 50) and proceed directly with viewing the add/edit menu 51,52.

Computer program modules preferably are written to implement the various steps of the process. For example, a module controlling the sponsor user identity process may be created to hold all variables related to a sponsor user's identity and to cases of that sponsor.

A “Validate New Participant Name” module may be created which is called when the user places an entry in the user name field and leaves the field form. Preferably, the user name entry form has a JavaScript object which checks to see if the username has already been taken, and if so, displays an error message.

In step 52, the participant is presented with the choice of adding/editing variable selection choices, viewing all sessions for that sponsor, or logout. As mentioned previously, preferably all or a portion of the data in the system may not be withdrawn after a period of time in which event the participant user will no longer be permitted to modify that information. Preferably a menu is provided in which the participant may choose one of two links to separate functions. For example, a menu bar may be provided on the left hand side of the screen in which the participant chooses by clicking on the appropriate box in the menu bar corresponding to the function.

Alternatively, the add/edit menu may appear prior to login and immediately following the choice step, 47. The participant's choice is then saved through intermediate login and contract screens which follow.

In Step 49 the user is preferably shown a system participation agreement if the correct name and password were entered. The agreement preferably details the terms of use of the system and details regarding the process. Preferably, a button is provided on the menu for either agreement or disagreement with the contract. If the participant agrees to the terms of the contract, he or she proceeds to the original menu choice (adding/editing cases, or viewing cases). Otherwise, the participant is returned to the login screen with all information cleared.

If the participant agrees to the participation agreement, the system may send the participant to the original menu choice in step 52. Alternatively, the system may be designed to send the participant to a menu with the options of assigning a new session, reviewing sessions, adding/editing sessions or logging out.

If the adding/editing session choices was originally chosen, the program enters step 52 where an Add/Edit session screen preferably allows the participant to enter the following information into the database:

Participant name

Session Description

Session Sponsor Case ID (If applicable)

Variable choices made. Where variable is an individual such as an arbitrator or mediator, the individual name, firm, address, city, state, zip code, Participant telephone, fax, and email

In cell phone, and telephone-based embodiments, some or all of this information may be entered with the assistance of system administrators.

The Session Sponsor case ID is preferably a value for sponsor internal tracking selected by the sponsor.

The data inputs representing variable choices made need not all be entered at one time. The system will prompt the participant to enter a choice for the number of variable selection choices pre-determined by the initial participant, with the option to leave one or more selections undetermined, leave the session and return to the session at a later time.

The screen also may display the status of the session, showing participant choices to the point of session logon. Upon submitting logon information, the participant may be returned to a confirmation screen with all previously entered information upon which the user can choose to accept the changes or return to edit the case further. Preferably, the system provides the participant with a period of time, for example, thirty minutes, to edit some or all of the session information before that information becomes final. For that information made final, after the period of time has expired, further edits may be done preferably only with the agreement of all the parties.

Preferably, the Add/Edit screen includes a “submit” button at the bottom, which sends the information to be checked for formatting. It points out missing or improperly formatted text, or returns the text for verification. If the text is accepted, the data is sent to the database for entry as an addition or update 55. If the participant is the last participant in a session to submit his or her variable choices, and time has expired for the other participants to make changes to their variable choices, upon acceptance of the last participant's data, the random variable selection process will be initiated 56. Preferably, once a session is opened, a session sponsor user cannot edit a session except to change clerical information regarding the session sponsor's ADR roster, such as address and phone number.

When a session sponsor uses the system, the sponsor will may access a Session Data Entry module created to hold a template that processes the session sponsor user's entry of session data and add/insert it into the database. The main features of the program include permitting the session sponsor to open session by entering session and participant identification information, permitting the session sponsor to make one or more pre-designations of the session parameters, such as directory for data selection, and time, date and location of any selection related event, permitting the session sponsor to check on the amount of expired time in an on-going session, and permitting the sponsor to check to see whether or not all participants have completed their variable choices for random variable selection 51, so that the sponsor may send prompts to a non-complying participant where appropriate.

Preferably the program is written so that when a record is to be inserted, the insertion is held up and locked using a suitable program until the system can read the record in order for the details to be displayed back to the user within the screen for confirmation and in order that the system can provide a HREF to its primary key which is automatically assigned by the database.

Another module called “Session Sponsor Assigns Session” preferably drives the session sponsor user's entry of a session into the database.

If the original choice was viewing all sessions 51, the program moves to step 52 where the view session screen reveals all data for a given session which has previously been entered during an Add/Edit choice and which may be added to or edited. View screen may, if desired, also display a list of sessions that have been opened by a sponsor user.

Preferably, a module called “Session Sponsor User Show” contains a template which shows the user these records. If the session sponsor user has administrator privileges, the module shows all user records related to the session sponsor. A similar module called “Session Sponsor Show Session” preferably functions to show session information.

In step 54, the user may log out of the system from a menu choice to end the session and return the user to the login screen. This menu choice preferably also follows completion of the Add/Edit and View choices of steps 52 and 51. If a user attempts to engage the system again, he or she will have to login their session and/or user name/password pair. Preferably, logging out clears the password, but not the user name, so that upon subsequent login the computerized system may check for the user's name in the user's cookie if the user accesses the system with the same computer.

The screens appearing in the operation of the system may be created by suitable computer programs written in a Standard Generalized Mark-up Language such as Cold Fusion Script.

The computer program code for the Login screen creates the login form if a user is determined not to be in a logged in state. (FIG. 4, step 48). This form preferably passes on a variable value indicating the participant's eventual destination.

The module for the License screen follows the Login program and checks the participant's authentication credentials. If the participant passes, the License screen is shown (FIG. 4, step 49).

Preferably, a module called Login results follows the License module and sets the participant's state to logged in. Unless the participant has explicitly denied cookies on his or her browser, the program also checks to see if the participant's cookie has taken correctly and sends an error message if it does not. If all is correct, the module sends the user on to his or her selected destination.

A Logout module may be used to log a user out of the system. Preferably the next time the user tries to use a menu item, he or she will be prompted for a password and to approve the license agreement.

If the participant disagrees with the license, a module following the License module displays the Disagree screen which preferably indicates that the user must agree to the license in order to use the system.

An Access Denied screen may be created to show a participant who attempts to access a section he or she does not have authorization for.

A Default page for debugging purposes may also be used to show current user login status. Preferably, this page is for a system administrator, and other participants would normally not be able to access this page without mentioning it explicitly.

The above-described steps preferably apply equally to sponsor administrators (session sponsor users designated with administrator privileges). However, the system preferably may be designed so that if the participant is identified as holding administrator privileges, he or she will see an enhanced version of the sponsor user menu. In addition to providing the user with the option to open a new session, review sessions, and logout, the sponsor administrator menu provides the options to change sponsor information or change his or her own ADR panelist information.

If the change sponsor information option is selected, the program sends the user to change the sponsor information screen which allows the user to add/edit sponsor information stored in the database, including:

Sponsor Name

Address

City

State

Zip Code

Phone

Fax

Email

Computer modules preferably contain the screen forms for entering and editing sponsor user and new sponsor user information. These modules also may screen users for administrator privileges, for example, before allowing the user to edit records.

Many of the above-described steps preferably also apply to participant or participant's attorney, for example, an attorney that represents an individual or company that has dispute or has initiated an arbitration or mediation with a sponsor who has entered into a participation agreement to use the system.

The attorney may be notified, for example, by regular mail, or e-mail, that he or she can login to the website and submit a specified number, for example three, variable selection choices for random variable selection, which in the ADR example would mean select three arbitrators or mediators from a designated directory to be placed into the data pool from which the random variable selection process would select the arbitrator or mediator for the case. The attorney would be notified that his choices must be made according to pre-established conditions. The attorney may be required to sign a participation agreement, preferably mailed or e-mailed to him or her, before given the proper login credentials. Once the attorney signs and forwards the agreement to the system administrators, the attorney is given the proper login credentials.

As in the case of participant or session sponsor users, the claimant attorney opens his or her web browser and accesses the system website (See FIG. 4, step 46). The attorney, however, chooses an “enter as Attorney” option provided on the menu that appears.

In step 47, the attorney is presented with the choice of reviewing sessions where he represents a participant. Preferably a menu is provided in which the user may choose one of three links to separate functions via a menu bar on the left-hand side of the screen. As in the case of the session sponsor user, the claimant attorney's choice is saved through intermediate login and contact screens which follow.

The program next moves to step 48 in which the attorney, session sponsor, participant or other user must first log into the system before making variable choices for random variable selection. A “Login” computer file for an attorney similar to the “Login” file for the sponsor preferably implements this step. Preferably, the attorney/user must enter a case identification number, a security code, for example, an internally generated random number which functions as a password), and an attorney security code (preferably, a code generated by the session sponsor). If these do not match the information known by the database, the attorney/user is shown an error screen with the option to try again.

As in the case with the session sponsor user, step 49 shows the attorney a system participation agreement if the correct name and password were entered with the same options and results discussed previously. A “License” file similar to the “License” file for the sponsor user preferably implements this step.

If the attorney/user agrees to the terms of the agreement, he or she proceeds to the original menu choice (reviewing sessions and/or entering variable selection choices). Alternately, the system may be designed to send the attorney/user to a main menu with the options of obtaining session information or entering or editing variable selection choices. A “Login-Results” file and a “Disagree” file similar to corresponding files for the sponsor user follow the “License” file to implement this step depending on whether the attorney/user agrees or disagrees. Similarly, “Logout”, “Access-Denied”, and “Default” files corresponding to similar files for sponsor users preferably are provided.

If the session information option was selected, a case information screen is provided which preferably allows the attorney/user to view the following information from the database:

Session Name

Status

claimant Name

Attorney name

Attorney firm

Attorney address

Attorney city

Attorney state

Attorney zip

Attorney telephone

Attorney fax

Attorney email

Preferably, the screen displays the current status of other participant's input into the session with the corresponding details of the session without the ability of the attorney to edit any of this information. A module controlling the session status process may be written to hold all variables related to an attorney's session. An “AttorneySessionInfo” module may also be created which displays the information an attorney needs to start making variable selection choices. Preferably, the data in the module may not be withdrawn.

Preferably, the screen provides a form box in which the attorney places the preset number of variable choices. After the attorney has placed all variable choices permitted him in this session, his choices are submitted to the database for addition to the data pool of variables. The attorney is logged off the session by entry of the required number of variable choices.

Once all attorneys or participants have made their variable selection choices, the random variable selection process is automatically initiated and the preset number of variables are automatically chosen from the data pool, with notification made to all participants.

Preferably, the system is administrated by a system administrator who may be an employee of a third party who has been granted login rights to the administration function of the system for the purpose of adding sponsors, generating reports, or performing customer service on the website.

The system administrator reaches the website by opening his or her web browser, pointing it at the website interface and entering in appropriate identification numbers or passwords identifying him or her as an administrator. A module may be created which contains an administrator form for the assignment or editing of a case.

The administrator may then be presented with an administrator menu which provides the following menu choices:

Session Sponsor options, including the options to add/edit a sponsor and to show a list and links to all sponsors,

User options, including the options to show users (preferably a list and links to all sponsor users, searchable by user name and sponsor name), to add a new user, and to delete a sponsor user,

Session options, including the options to show sessions preferably by a list and links to all sessions, searchable by session name, sponsor name, start date, end date and status, to assign a new case, and to delete a case, and

Site options (testing modules) including the options to clear cookies for the purpose of losing stored login information, to logout for the purpose of logging out the system and if desired to clear cookies, and to show login status for current login details.

Preferably, modules may be created to facilitate these options. For example, an “AdminNewSponsorUserEntryForm” module may be created which contains an entry form to enter a new sponsor user. Preferably, this form is different from the regular form because of the participant username checking that occurs during the participant's interaction with the page.

An “AdminGetSponsorNewSessions” module may be created which chooses a sponsor for the purpose of adding a new session. Preferably, the identity of the sponsor should be known when a session is added so that the session may be properly assigned to a sponsor user.

An “AdminShowSessions” module may also be created which shows all open sessions in an administrator form. An “AdminSponsorUserDataEntry” module may also be created to hold a template which inserts or updates a sponsor user. The module makes a query to obtain the primary identification of the user, if the system does not have this information, in order for the system to set an edit link.

An “AdminSponsorUserEntryForm!” module may also be created to hold a template representing the entry form for sponsor user administrator information. An “AdminUserShow” module may also be created which contains an administrator form to show all users.

A “SessionDataEntry” module may also be created which contains a form to enter/insert sessions into the database.

If the Add/Edit a Sponsor option is chosen, an Add/Edit a Sponsor screen preferably appears to allow the administrator to view/edit the following information from the database:

Sponsor name

Address

City

State

Zip Code

Phone

Fax

E-Mail

System ID

Active Account (yes or no)

“SponsorDataEntry”, “SponsorEntryForm”, and “SponsorShow” modules may be created to add a new sponsor to the database and show a return page, to contain an entry form to enter a new sponsors and to show a table of all sponsors entered into the system.

“ValidateNewParticipantName” and “ValidateParticipantName” modules may be created which check to see if a participant name exists in a sponsor table and if so, display an error message. Preferably, these modules are called from a JavaScript lost focus event. The ValidateNewParticipantName module preferably gives no consideration to the current username as it assumes that there is none.

The “DeleteParticipant” option provides the administrator with screens in which the administrator can change, delete or add information to any sponsor user's record as in the case with the sponsor administrator's remove a user option. Preferably, a “DeleteParticipant” module and a “RemoveParticipant” module may be created which show the form that allows a user to delete a sponsor user and perform the database call to remove a user.

The “Add/EditSession” option provides the administrator with an “Add/EditSession” screen similar to the sponsor administrator's “Add/EditSession” screen. In addition, the system preferably allows the administrator to add session status information including:

Session Status

Last sponsor edit (date-time)

Edited by

Sponsor name

Last attorney edit (date—time)

Last administrator edit (date—time)

A “DeleteSession” module and a “RemoveSession” module may be created to show the form that allows the user to delete a session and to perform the database call to remove a session.

Preferably, the system also provides a report writer or searchable module of session information for reporting purposes. By querying the report writer, the status of any number of session may be viewed by the administrator for the purposes of internal reporting.

Preferably, session information may be searched based on the following criteria:

Session Name

Sponsor name

Status

Assigned date (start and finish dates)

Modified criteria (start and finish dates, for example, all records modified in a particular day)

Show only records unmodified by an attorney

The selected platform and hardware to implement the system should be scalable enough to handle large loads of traffic and data, while being responsive to user requests.

Similarly, the database chosen should be scalable enough to handle a distributed data environment, and to be able to handle large loads of data, while being responsive to user requests.

The application server likewise should be scalable enough to handle a distributed data environment, and to be able to handle large loads of data, while being responsive to user requests. Preferably, the application server is a popular platform in which to build applications of this type in order to support future changes, add-ons, modifications, etc.

The server preferably is an open architecture computer that has the ability for failed hardware parts to be replaced swiftly. This configuration also maintains the availability to increase the power of the machine or demand. For example, a computer having an Internal Pentium 400 MHz Processor, with 128 MB SDRAM, two 4.2 Western Digital Hard Drives, a Promise PCI-RAID Level 0 Controller, a 32xCD-ROM, and 3-COM 10-BaseT Ethernet Card is suitable for use in the system.

The platform for use in the system preferably has the ability to work with open database systems, provide a reliable and scalable platform for intranet and line of business applications, and offer breed file and print services that give users easy and effective access to information and resources. For example, Microsoft Windows NT Server 4.0 system, a powerful multipurpose server operating system, is a suitable platform because of its broad support of many application servers, its scalabilty to support the system of the present invention and its popularity with developers who create applications of this type. The platform preferably integrates the following services into underlying operating system infrastructure:

Built-in networking and communication services,

Comprehensive Web services for the Internet and corporate intranets,

Complete platform form for distributed applications,

Enterprise-wide directory services,

Integrated and robust security services,

Easy-to-use and flexible management services.

The system of the present invention preferably uses a webserver, such as Microsoft Internet Information Server 4.0, that offers proven scalability and tight integration with the operating system and other products used in the system. The web server preferably includes publishing features, customizable tools, and technologies that permit the creation of Web pages, the publication of information to the World Wide Web, the sharing of files and data on operating systems such as Windows NT, Novell NetWare and UNIX servers, and over numerous databases, including Microsoft SQL Server, Oracle, and Sybase databases, and the search capacity for content in HyperText Markup Language and Microsoft Office document types, and multiple languages.

Preferably, the webserver offers process isolation, a feature which protects applications and Web sites from failure caused by misbehaving components or Web-applications on the server by running them in separate memory spaces. The webserver should also have when combined with the operating system built-in distributed application services that automatically scale to serve thousands of simultaneous users.

Preferably, a high performance, open architecture, scalable database, such as Microsoft SQL Server 6.5, is used in the system.

The computer program is preferably one which provides a scalable platform to deliver high performance Web applications with any major Web server on Windows or Solaris. Allaire ColdFusion Application Server 3.1 and its cooperating ColdFusion Markup Language are suitable for use in developing the system.

Preferably, the system is hosted at a quality data center, such as a worldwide data center company which provides access to the Internet and monitors the servers to ensure that they are responding to Internet requests.

What we claim is:

1. A computer executable method for random selection of a one or more variables from a pool of variables chosen by one or more participants, operative to control a computer, and memory means stored on at least one computer readable medium, the method when executed comprising:
(a) allowing an initial participant or a session sponsor who does not participate in variable selection, to open a session for random variable selection, including designation of session parameters, by:
i. where desired, identifying the categories of variable choices submitted for which final variable selection shall be made,
ii. setting the number of variable choices for each identified category that each invited participant shall be permitted to select,
iii. designating the number of final selections that will be randomly selected from the sum total of all participants' variable choices,
iv. identifying all participants that will be invited to participate in the random variable selection process by submitting variable choices to be entered into the data pool from which final variable selection(s) shall be made,
(b) notifying the session participants that they have been invited to participate in the session for random variable selection,
(c) notifying the session participants regarding the parameters of the session for random variable selection to which they have been invited,
(d) permitting each participant in the session to make one or more variable choices,
(e) entering the choices made by each participant into a data pool from which random variable selection shall be made,
(f) closing the data pool after the last participant has entered his variable choices,
(g) activating the random variable selection process after the entry of the last participant's variable choices,
(h) transmitting notification to each session participant, initial participant and where applicable to the session sponsor regarding the selected variable(s),
whereby a random variable selection has been made in which all participants have contributed variable choices and are confident in the neutrality of the outcome and the fairness of the process.

2. The method of claim 1 wherein one or more parameters of one or more sessions for random variable selection are pre-designated by the session organizer or initial participant, with said parameters including where desired:
(a) designation of the directory, computer, media card, cd, dvd, floppy disk, intranet site, internet site, catalog, book, or other data group from which session participants are to make their variable choices where such designation is desired,
(b) identifying and setting the number of variable choices each invited participant shall be permitted to select,
(c) designating the number of final choices that will be randomly selected from the sum total of all participants' variable choices,
(d) publishing, where desired, each invited participant's variable choices to the other participants prior to the final selection by the random variable process,
(e) permitting, where desired, each invited participant to eliminate or “strike out” one or more of the other participants' variable choices,
(f) designating the time, date, place and/or forum for any event associated with the random variable selection.

3. The method of claim 1 further including wherein the variable sources from which participants make their variable choices are stored or made accessible to participants on one or more of the following:
(a) a computer serving an Internet web site or bulletin board site,
(b) on an Internet or Intranet site,
(c) on a compact disk,
(d) on a digital video disk,
(e) on a floppy disk,
(f) on a computer,
(g) on a media card,
(h) in a traditional paper directory or book,
(i) in the memory of the participant based upon experience or first hand knowledge,
(j) on any commercially available data storage unit.

4. An automated method of permitting one or more participants to select one or more variables from a designated larger directory, catalog or group of variables, to submit said variables for inclusion into a data pool, and for random selection of designated number of variables from said data pool, comprising:
(a) receiving an engagement request from either a session sponsor, or an initial participant to begin a session for automated, random variable selection system,
(b) receiving session parameter information from either the session sponsor or the initial session participant, including number of participants, number of variables selection choices from each participant, and number of variables selected from all variable selection choices submitted by all participants,
(c) receiving identification and contact information for all other participants from the initial participants,
(d) sending requests to the remaining participants to engage the automated random variable selection system to make one or more variable selection choices and to be bound by that selection,
(e) receiving one or more variable selection choices from each session participant,
(f) receiving where permitted by the initial session parameters, participants' instructions to eliminate a set number of choices made by other participants in order to allow the “striking out” of submissions felt to be wholly unacceptable,
(g) receiving, where required, payment for the random variable selection process from one or more session participants prior to the close of the session,
(h) closing the data pool once the last selection has been made by the last participant to make a selection,
(i) maintaining, where desired, inaccessibility of the session from non-participants,
(j) compiling all variable selections from all participants into a data pool,
(k) eliminating, where required by initial session parameters, “strike out” variable choices made by the participants,
(l) making one or more random variable selection choices from the data pool comprised of all variable selections from all session participants, excepting the choices eliminated by strike outs in those sessions permitting variable strike outs,
(m) notifying all participants, and where applicable, the session sponsor, of all random variable selection choices made,
whereby random variable selection(s) has been made from a larger directory, catalog or group of variables in which all participants have contributed variable choices and are confident in the neutrality of the outcome and the fairness of the process.

5. A computerized method for one or more participants to obtain a random variable selection from data selected by them from information made available in a directory, catalog or other data grouping contained on an Internet website or other communications linkage through at least one central processing unit including operation system software for controlling the central processing unit, with said method further comprising:
(a) permitting sponsorship of a session for random variable selection wherein the sponsor administers the session, but does not participate directly in the data selection process,
(b) allowing a sponsor or an initial participant access to a directory, catalog or other data grouping of data or variables contained in an Internet or other website,
(c) allowing the sponsor or initial participant access to point located at the Intranet or Internet directory, catalog or other data grouping which activates the random variable selection process,
(d) permitting the sponsor or initial participant to identify and activate a session for random variable selection by activating software stored in at least one central processing unit from an activation point located at the website containing the directory or catalog or other data grouping,
(e) allowing the session sponsor or initial participant to set the parameters of the session, including participant identification, number of variable choices made by each participant, number of variables selected by the random variable selection system, and whether the selection process shall permit each participant to eliminate or strike out a set number of another participant's variable choices,
(f) notifying, via Internet or other communications linkage, all participants identified by the sponsor or initial participant that they are invited to participate in the session opened by the initial participant,
(g) permitting the identified participants to make variable choices from amongst the variables associated with the directory, catalog or website of variables,
(h) receiving one or more variable choices from the identified participants, including where permitted by initial session parameters, strike out choices for eliminating a set number of other participants' submissions, with at least one such set of variable choices from at least one such participant having been received via an internet connection,
(i) further receiving such variable choices via a password protected communication link, having an associated sequence number,
(j) storing the participants' variable choices into a data pool in the central processing unit until the last participant in the session submits his variable choices,
(k) activating an algorithm that makes a random variable selection amongst the choices submitted by all participants after receipt of the last variable choices from the last participant,
whereby random variable selection has been made from a larger directory, catalog or group of variables located on a website on the Internet in which all participants have contributed variable choices and are confident in the neutrality of the outcome and the fairness of the process.

6. The method of claim 5 including accessing the activation point for random variable selection at an Internet website by utilizing a web browser and computer key board, cell phone, personal data assistant or other device having Internet capabilities.

7. The method of claim 5 further including wherein the participants in the process maybe one of:
an insurer, a claims adjuster, or an attorney for an insurer,
a sponsor, a sponsor administrator, or a sponsor system administrator,
a participant in an alternative dispute resolution process,
a party involved in litigation,
an agent of a self-insured organization,
a claimant, a representative of a claimant, or an attorney for the claimant,
a respondent, a representative of a respondent or an attorney for a respondent,
a plaintiff, a representative of plaintiff or an attorney for plaintiff
a defendant, a representative of defendant, or an attorney for defendant.

8. The method of claim 5 wherein the initial entity is a session sponsor, setting the parameters of a random variable session, but is not an actual participant in the session, such as one of the following:
a host organization,
a dispute resolution organization or company,
a governmental entity,
a chamber of commerce,
a commercial group,
an insurance company,
a non-profit association.

9. The method of claim 5 wherein a session for random variable selection is activated from a website containing a directory or listing of professionals, such as arbitrators or mediators, with individuals listed in said directories selected as variable choices by those participating in the session.

10. The method of claim 5 further comprising steps stored in an automated random variable selection system including a processor and storage, for random variable selection, the method comprising:
(a) a step of executing a first program module, written in a markup language, for receiving values submitted by an initiating party via the Internet, the values representing parameters for opening a session for random variable selection from a designated directory, catalog, or other variable group, including number and identity of participants, number of variables to be chosen by each participant, and number of variables to be selected from all participants' variable choices,
(b) a step of executing a second program module, written in a markup language, for receiving values submitted by the participants via the internet, the values representing variable choices to be utilized in random variable selection, including where instructed by initial session parameters, values representing variable choices for elimination from the random selection process,
(c) a step of executing a program object, written in an object oriented programming language, for randomly selecting one or more variable choices from amongst all individually submitted variable choices and for generating a variable choice indication,
(d) a step of executing a fourth program module for informing all session participants which variable choice was selected and,
(e) a step of executing a fifth program module for informing any individual randomly selected by the program where there variables submitted were chosen from a directory of individuals.

11. The method of claim 5 further including one or more of the following steps for logging each session sponsor or initial participant into a session:
(a) a step for enabling a session sponsor or initial participant to pre-designate the session parameters for one or more sessions for random variable selection prior to participation by the session participants,
(b) a step for checking administration authorization of a sponsor prior to sponsor administration of a random variable selection session,
(c) a step requiring the session sponsor or initial participant to log into a session for random variable selection prior to performing any administrative functions within said session, preferably with said log in requiring submission and acceptance of at least two security numbers or access codes,
(c) a step for acceptance and processing of payment amounts for the random variable selection process when payment is charged,

12. The method of claim 5 further including wherein:
(a) cookie data is sent by the directory, catalog or other group of variable choices located at an Intranet website for storage on a hard drive associated with the initial and subsequent participants in a session for random variable selection, in order to track usage by the initial and subsequent participants.
(b) third signals are received from directory, catalog or other group of variable choices for forwarding to a computer associated with either the initial or subsequent participants which, when received, would cause the computer to retrieve the cookie data from the hard drive and send it to the computer hosting the directory, catalog or other group of variables.

13. A system comprised of:
(a) a set of initial values, representing the parameters for random variable selection, selected by the initial participant, including the identity and number of subsequent participants, the number of variable choices to be made by each one, and the number of variables to be selected from a data pool of all variable choices made by all participants,
(b) sets of subsequent values submitted by subsequent participants to the random variable session,
(c) a proxy including an input, an output and a computer executable program, the program being structured to, when executing, accept sets of values representing variable choices from different entities via the input and return a result indicator to the proxy based upon a mathematical computation for random selection amongst all variable choices made by all participants, the program being further structured to provide notification of the chosen variable to all participants, and to the chosen variable when said chosen variable is an individual.
(d) processor accessible storage configured to temporarily store all values submitted by all participants for retrieval by the proxy via the input,
(e) a computer executable program including a plurality of modules, one of which is programmed in an object oriented programming language, including JAVA Script, and another of which is programmed in a markup language, including Cold Fusion Markup Language and Hyper Text Markup Language,
(f) when the program is executed and the result indicator indicates that the predetermined criterion is satisfied, the proxy randomly selects one or more variables from the stored values, then discards the remaining values,
(g) after random variable selection, the proxy then discards remaining values and notifies all participants as to the variables chosen.

14. The system of claim 13 wherein predetermined parameters for random variable selection may include:
(a) that the values submitted for random variable selection represent individuals who are alternative dispute resolution neutrals, such as an arbitrator or mediator,
(b) that the values be obtained from a directory located at an Internet or Intranet site,
(c) that the values be submitted on line via a form accessible at a website and filled out by way of web browser and computer key board,
(d) participants may be prohibited from making a withdrawal of the submitted values representing variable choices, then variable choices made may be published to all other participants, and participants allowed to strike out or eliminate one or more of an other participant's submitted values representing variable choices.

15. The system of claim 13 further including:
(a) an entity accessible detail log written in a markup language, with a correlation of chosen values and session specific information,
(b) proxy accessible storage for said log, into which the proxy can store the values and data representing session specific information when the result indicator indicates that the predetermined criterion is satisfied,
(c) an entity searchable database including data relating to variable choices and to completed random variable selection sessions,
(d) a communication link over which a session participant can search a directory/database for selection of variable choices, prior to submitting one or more variable choices to the data pool from which one or more random variable selections shall be made prior to the close of a session.

16. A computerized method for one or more participants to make one or more random variable selections of variables which may be required for Alternative Dispute Resolution such as the time, date, place and forum for Alternative Dispute Resolution and the selection of Alternative Dispute Resolution professionals or neutrals required for Alternative Dispute Resolution, such as arbitrators or mediators, stored on at least one computer accessible storage medium for execution by a processor comprising a plurality of modules which, when executed by the processor:
(a) enables either a session sponsor sponsoring a session for random Alternative Dispute Resolution neutral selection or the initial participant in a session for random Alternative Dispute Resolution neutral selection to open a session for random variable selection identifying the other session participants,
(b) enables the session sponsor or the initial participant to set the parameters of the opened session, which said parameters may include identifying session participants, designating the directory or source from which Alternative Dispute Resolution neutral choices may be made, setting the number of Alternative Dispute Resolution neutral choices each participant may enter into the data pool from which the final Alternative Dispute Resolution neutrals shall be selected, and identifying other selection variables for which participants may enter selection choices, such as time, date, place and forum choices from which final selections may also be chosen by the random variable selection process,
(c) permits, where desired, each invited session participant to conduct a search of any designated directory or source of Alternative Dispute Resolution neutrals in order to narrow their selection choices for submission to the data pool from which the random variable selection process shall make the final variable selections,
(d) permits each invited session participant to make final designations of one or more choices as their submissions to the data pool from which the random variable selection process shall make the final variable selections,
(e) permits, if allowed by the initial session parameters, each participant to eliminate a set number of choices made by other participants in order to allow the striking out of submissions felt to be wholly unacceptable,
(f) compiles the values representing all participants' final variable choices into data pools from which the random variable selection process shall make final variable selections,
(j) closes the random variable selection session after submission by the last session participant of his or her final variable choices for random variable selection,
(k) randomly selects one or values as the final selections from all submitted choices made by all session participants,
(l) notifies all session participants of the Alternative Dispute Resolution neutrals selected, and, where included in the initial session parameters, of the other variable choices made, by the random selection process,
(m) notifies the Alternative Dispute Resolution neutrals selected by the random selection process that they were selected as the Alternative Dispute Resolution neutrals for dispute resolution by the session participants,
(n) closes the session after Alternative Dispute Resolution neutral selection and notification, whereby random Alternative Dispute Resolution neutral selection has been made in which all participants have contributed neutral selection choices and are confident in the neutrality of the outcome and the fairness of the process.

17. A computerized system for automated random variable selection of the variables submitted by one or more participants that are required for Alternative Dispute Resolution, with selection of said variables including, where desired, the Alternative Dispute Resolution professionals, such as mediators or arbitrators, required for Alternative Dispute Resolution, time, date, location and forum for Alternative Dispute Resolution, comprising:
(a) a processor for variable selection choices from participants;
(b) means for introducing to the processor, via a communications linkage, information identifying a session for random variable selection and a series of variable selection choices made by participants in a session,
(c) means for accepting said series of variable selection choices submitted by participants into a data pool comprised of all said variable choices,
(d) means for allowing, pre-submission, comparison of the variable selection choices made by the participants in the variable selection process in order to narrow their selection choices,
(e) means for discarding the values representing variable choices lacking qualification criteria selected by the participants,
(f) means for displaying the values representing variables meeting the qualification criteria on a spreadsheet display accessed over the Internet so that the participant can easily compare values representing remaining professionals,
(g) memory means, accessible by the processor, for storing the information identifying the session and for temporarily storing the series of variable selection choices made by participants to a session without disclosure of the series of choices to an adverse entity or non-participant,
(h) comparison means, in communicating relationship with the processor, for receiving and comparing one of the series of variable choices with another series of variable choices, and making a random variable selection that, if required by initial setting of session parameters, eliminates double entries in the final round so that there are no duplicate listings of variable choices, and that, if further required, compares session choices by multiple participants, and eliminates a set number of choices made by each as directed by another participant to permit to strike out submissions by other participants that they feel are wholly unacceptable.

18. The system of claim 17 wherein the communication linkage is comprised of one of the following connections:
(a) an Internet connection,
(b) a voice connection,
(c) personal digital assistant or other electronic device,
(d) any other commercially available connection permitting data input.

19. The system of claim 17 further including security means for preventing access of the system until provision to the system of at least one of:
(a) a case identification number identifying the session,
(b) a security code corresponding to the session, or
(c) an administrator code for the person or the entity.

20. The system of claim 17 further comprising time keeping means for associating an entry time with at least the first of the series of variable choice selections in a session and the last made series of variable choice selections in a session.

21. The system of claim 17 wherein all of the series of variable selections made by participants in a session are received by the system at different times.

22. A computerized system for automated random variable selection through a communications linkage for communicating and processing a series of variable choice selections by different participants in a session for random variable selection through at least one central processing unit including operating system software for controlling the central processing unit, means for introducing information into the central processing unit corresponding to the identification of the session for random variable selection, the parameters of the session and the persons involved in the session, memory means for storing the information corresponding to the identification of the session, the parameters of the session, and the persons involved in the session, means for introducing by or on behalf of a the initial participant in the session, information into the central processing unit corresponding to a series of variable selection choices, means for introducing, by or on behalf of all subsequent participants, information corresponding to a series of variable selection choices, and means for storing the results of the random variable selection process generated by the system.

23. A computerized system as defined in claim 22 further comprising means for accessing actual session results generated by the system in other sessions.

24. A computerized system as defined in claim 22 wherein said participants communicate via one of the following mechanisms:
(a) via the Internet to said central processing unit,
(b) via telephone to said central processing unit,
(c) via personal digital assistant or other electronic device,
(d) any other commercially available data input device.

25. A computerized system as defined in claim 22 including security means whereby the system is accessible only upon entry of a session identification number identifying the session, a security code corresponding to the session, and a user security code corresponding to the session and identifying the participant or representative thereof who is making a variable selection choice for random variable selection.

26. A computerized system as defined in claim 22 comprising time keeping means to record the introduction of the information corresponding to the variable choices made by participants over a period of time.

27. A computerized system as defined in claim 22, including means for introduction of information corresponding to variable selection choices, which may be made in a plurality of communications with the system over a period of time.

28. The system of claim 22 wherein the markup language is Hyper Text Markup Language or Cold Fusion Markup Language.

29. The system of claim 22 where the object oriented programming language includes JAVA Script.
